(19) United States
(12) Patent Application Publication
(10) Pub. No.: US 2024/0406359 A1
(43) Pub. Date: Dec. 5, 2024

(54) INSPECTION METHOD, NON-TRANSITORY RECORDING MEDIUM RECORDING COMPUTER PROGRAM, AND PROJECTION SYSTEM

(71) Applicant: Panasonic Intellectual Property Management Co., Ltd., Osaka (JP)

(72) Inventors: Mitsuhiro ISHIZUKA, Osaka (JP); Yoshinao SUGIURA, Osaka (JP)

(21) Appl. No.: 18/804,921

(22) Filed: Aug. 14, 2024

Related U.S. Application Data
(63) Continuation of application No. PCT/JP2023/007919, filed on Mar. 2, 2023.

(30) Foreign Application Priority Data
Mar. 11, 2022 (JP) 2022-038557

(51) Int. Cl. H04N 9/31; G06T 7/73

(52) U.S. Cl. CPC H04N 9/3194; G06T 7/74; H04N 9/3185; G06T 2207/30204

(57) ABSTRACT

An inspection method of geometric correction executed by an arithmetic device accessing to a storage including: storing, in the storage, a pattern image including a plurality of feature points indicating coordinates on an image to be projected by a projector onto a projection surface; and by the arithmetic device, causing the projector to project the pattern image onto the projection surface, acquiring from an imaging device first captured image data including the pattern image, comparing a feature point included in the first captured image data with each of the plurality of feature points included in the pattern image, to extract a plurality of non-projected feature points that are not to be projected on the projection surface, and generating non-projected feature point data in which the plurality of non-projected feature points extracted are arranged at corresponding positions in a range of a projection image to be projected by the projector.

### BACKGROUND

### 1. Technical Field

The present disclosure relates to a projection system that projects an image onto a projection surface using a projector, an inspection method of geometric correction in the projection system, and a computer program.

### 2. Description of the Related Art

In recent years, projectors have been used in various situations. The projector may perform geometric correction to display a desired image. In addition, variations of a projection surface on which an image is projected by a projector are also increasing, and the projection surface is not limited to a quadrangular planar projection surface, and may be a projection surface such as a curved surface, for example. When the projection is performed on such a curved projection surface, the geometric correction becomes more complicated.

For geometric correction of the projector, there is also a method of capturing an image projected by the projector using the imaging device and automatically performing geometric correction using the captured image. For example, Patent Literature (PTL) 1 also discloses a technique for providing correction information enabling accurate correction of distortion of a projection image.
PTL 1: Unexamined Japanese Patent Publication No. 2015-57876

### SUMMARY

However, in the conventional automatic geometric correction, the processing of the automatic geometric correction cannot be checked, and the cause of the failure of the geometric correction cannot be specified. For example, in the geometric correction, it is necessary to associate the coordinates of the original image to be projected by the projector, the coordinates of the projection image output from the projector, the coordinates on the projection surface on which projection is performed by the projector, and the coordinates of the captured image obtained by capturing the image on the projection surface. On the other hand, in the automatic geometric correction, the information regarding the correspondence between these coordinates cannot be confirmed as the intermediate data.

The present disclosure provides an inspection method, a computer program, and a projection system that facilitate determination of validity of geometric correction in automatic geometric correction at the time of projection by a projector.

An inspection method according to the present disclosure is an inspection method of geometric correction in a projection system that causes a projector to project an image on a projection surface, the inspection method being executed by an arithmetic device accessing to a storage, the method including: storing, in the storage, a pattern image including a plurality of feature points indicating coordinates on an image to be projected by the projector onto the projection surface; and by the arithmetic device, causing the projector to project the pattern image onto the projection surface, acquiring from an imaging device first captured image data including the pattern image projected on the projection surface, comparing a feature point included in the first captured image data with each of the plurality of feature points included in the pattern image, to extract a plurality of non-projected feature points that are not to be projected on the projection surface, and generating non-projected feature point data in which the plurality of non-projected feature points extracted are arranged at corresponding positions in a range of a projection image to be projected by the projector.

These general and specific aspects may be achieved by a system, a method, and a computer program, and any combination of these.

The inspection method, the computer program, and the projection system of the present disclosure can facilitate determination of validity of geometric correction in automatic geometric correction at the time of projection by a projector.

### BRIEF DESCRIPTION OF THE DRAWINGS

FIG. 1 is a block diagram illustrating a projection system according to a first exemplary embodiment.

FIG. 2 is a diagram illustrating each configuration of the projection system of FIG. 1 disposed in a space.

FIG. 3 is a schematic diagram illustrating an image used by each configuration of the projection system in FIG. 1.

FIG. 4 is an explanatory diagram illustrating association of coordinates between an original image to be projected and a projection image projected from a projector.

FIG. 5A is a diagram illustrating an example of projected feature point data.

FIG. 5B is a diagram illustrating an example of non-projected feature point data.

FIG. 6A is a diagram illustrating an example of a pattern image including feature points.

FIG. 6B is a diagram illustrating an example in which the pattern image of FIG. 6A is projected.

FIG. 6C is a view illustrating an example of a relationship between the pattern image in FIG. 6A and the disposition reference marker.

FIG. 6D is a diagram illustrating an example in which a projection reference marker is displayed.

FIG. 7 is a diagram illustrating an example of visualized image data.

FIG. 8 is a diagram illustrating an example of result data.

FIG. 9A is a flowchart illustrating an inspection method according to the first exemplary embodiment.

FIG. 9B is a flowchart illustrating the inspection method according to the first exemplary embodiment, continued from FIG. 9A.

FIG. 9C is a flowchart illustrating the inspection method according to the first exemplary embodiment, continued from FIG. 9B.

FIG. 10 is a block diagram illustrating an image processor according to a second exemplary embodiment.

FIG. 11 is a schematic diagram illustrating an image used by each configuration of a virtual space generated by the image processor in FIG. 10.

FIG. 12A is a flowchart illustrating an inspection method according to the second exemplary embodiment.

FIG. 12B is a flowchart illustrating the inspection method according to the second exemplary embodiment, continued from FIG. 12A.

FIG. 12C is a flowchart illustrating the inspection method according to the second exemplary embodiment, continued from FIG. 12B.

### DETAILED DESCRIPTION

The present disclosure provides an inspection method, a computer program, and a projection system that facilitate determination of validity of geometric correction in automatic geometric correction at the time of projection by a projector. Specifically, according to the inspection method, the computer program, and the projection system of the present disclosure, in the automatic geometric correction of the projector, the processing of the geometric correction can be grasped by the user, whereby the appropriateness/inappropriateness of the geometric correction can be recognized.

Exemplary embodiments of the present disclosure will be described below with reference to the drawings. However, unnecessary parts in description regarding the related art and substantially identical configurations may be omitted in detailed descriptions. This is to simplify the description. Further, the following description and the accompanying drawings are provided to help those skilled in the art to fully understand the present disclosure and are not intended to limit the subject matter of the claims.

The following defines various terms used herein. The “projection surface” is a surface on which an image is projected by a projection device such as a so-called projector. The projection surface is not limited to a flat screen, and may be a curved surface or may be partially uneven. The “projection image” refers to an image output by a projector for projection onto the projection surface. The “projection surface image” refers to an image on a projection surface when the projector projects a projection image onto the projection surface. The “captured image” refers to an image captured by the imaging device.

The “geometric correction” refers to correction related to geometric distortion when projected from a projector onto a projection surface. For example, the geometric correction is correction for displaying an image that should be a quadrangle as a quadrangular image, in a case where the image is projected in a trapezoidal shape on a projection surface (trapezoidal distortion), in a case where the central portion is bulged (barrel distortion), or in a case where the central portion is contracted (spool distortion). Note that the geometric correction is realized by adjusting a parameter value in the projector.

The “virtual space” refers to a space virtually created by a computer representing an environment equivalent to the real space using space information representing a peripheral environment of the real space in which the projector and the projection surface are disposed.

The “space information” is information regarding a size including an area and a shape of a space, a building material constituting the space, lighting used in the space, a shape and a size of an object present in the space, a disposition position of the object, a material and a color of the object, and the like. For example, the space information may include a floor area and a height of a wall of the space, materials and colors of the floor and the wall, and the like. Furthermore, for example, in a case where a member such as a column or a beam exists in the space, the space information can include the shape, size, disposition position, material, color, and the like of these portions. The object existing in the space is preferably, for example, an object that constantly exists at a specific position in the space, such as an air conditioner. The space information can include coordinates indicating a disposition position of the display in the space. Furthermore, the space information can also include a size of a projection surface such as a screen, a position (coordinates, an angle formed by a projection direction of the projector and the projection surface, and the like), a material, a color, and the like of the projection surface.

### First Exemplary Embodiment

In the projection system according to the first exemplary embodiment, projection of an image by the projector and automatic geometric correction can be inspected using the image processor.

### <Projection System>

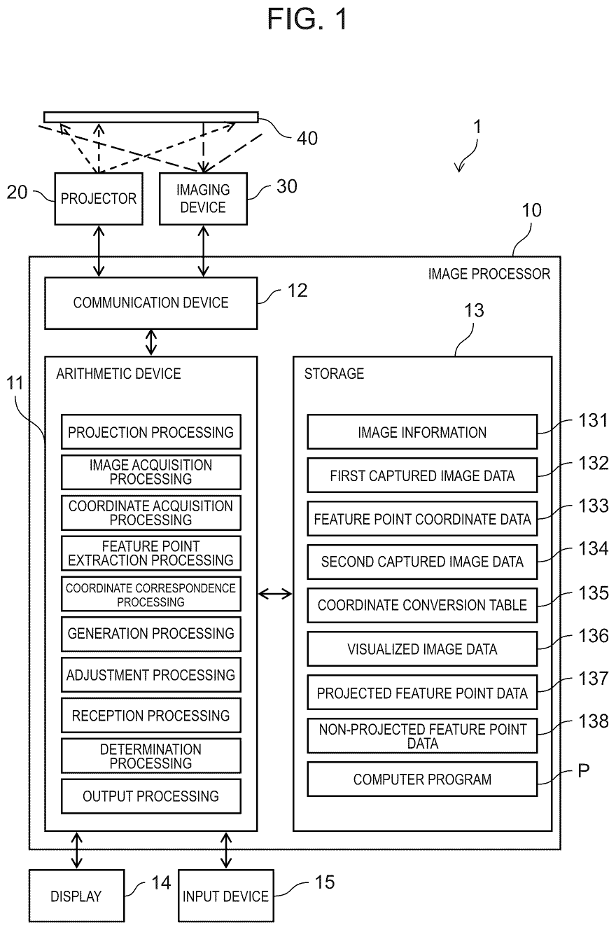

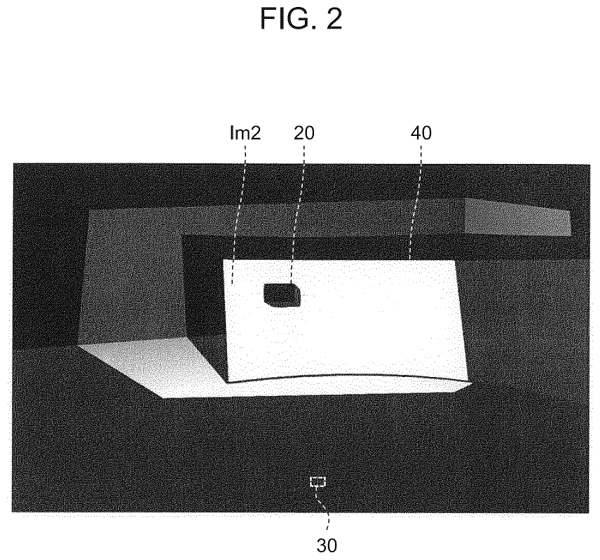

As illustrated in FIG. 1, projection system 1 according to a first exemplary embodiment of the present disclosure includes image processor 10, projector 20, and imaging device 30. Display 14 and input device 15 can be connected to image processor 10. FIG. 2 is a view illustrating a space including projection system 1.

In projection system 1, image processor 10 operates projector 20 to project an image on projection surface 40. Note that the “image” is not necessarily a still image, and may be a moving image. In the present specification, a still image will be described as an example of the “image”.

Imaging device 30 captures at least an image including projection surface image Im2 projected on projection surface 40 by projector 20 as a captured image. In the example illustrated in FIG. 2, the entire image projected from projector 20 does not fit within projection surface 40, and the image is projected to the outside of projection surface 40. In this case, image processor 10 geometrically corrects the projection image so that the entire projection image fits within projection surface 40.

### <<Image Processor>>

As illustrated in FIG. 1, image processor 10 according to the present disclosure is an information processor including arithmetic device 11, communication device 12, storage 13, and the like. Furthermore, arithmetic device 11 can be connected to display 14 and input device 15.

Arithmetic device 11 is a controller that controls the entire image processor 10. For example, arithmetic device 11 reads and executes computer program P stored in storage 13, thereby implementing various processing for executing inspection. Further, arithmetic device 11 is not limited to one that implements a predetermined function through cooperation of hardware and software, and may be a hardware circuit designed exclusively for implementing the predetermined function. That is, arithmetic device 11 can be implemented by various processors such as a CPU, an MPU, a GPU, an FPGA, a DSP, and an ASIC.

Communication device 12 is a communication means for enabling data communication with an external device (for example, projector 20, imaging device 30, and the like). The data communication described above is wired and/or wireless data communication, and can be performed according to a known communication standard. For example, wired data communication is performed by using, as communication device 12, a communication controller of a semiconductor integrated circuit that operates in conformity with the Ethernet (registered trademark) standard and/or the USB (registered trademark) standard. In addition, wireless data communication is performed by using, as communication device 12, a communication controller of a semiconductor integrated circuit that operates in conformity with the IEEE802.11 standard related to a local area network (LAN) and/or a fourth generation/fifth generation mobile communication system called 4G/5G related to mobile communication.

Storage 13 is a recording medium that records various kinds of information. Storage 13 is achieved by, for example, a RAM, a ROM, a flash memory, a solid state device (SSD), a hard disk drive, other storages, or an appropriate combination thereof. Storage 13 stores computer program P which is a computer program executed by arithmetic device 11, various data used for execution of inspection of automatic geometric correction regarding projection, and the like. For example, storage 13 stores image information 131, first captured image data 132, feature point coordinate data 133, second captured image data 134, coordinate conversion table 135, visualized image data 136, projected feature point data 137, non-projected feature point data 138, and the like.

Note that image processor 10 may be realized by a plurality of information processors connected to communicate with each other. In addition, a part of the data stored in storage 13 may be stored in an external storage, and image processor 10 may be configured to be read from the external storage and used.

Display 14 is a display means such as a display that displays data, an inspection result, and the like obtained in the processing of inspection. Input device 15 is an input means such as an operation button, a keyboard, a mouse, a touch panel, and a microphone used for operation and data input.

Image information 131 includes various image data projected from projector 20 onto projection surface 40 by the operation of image processor 10. For example, image information 131 includes image data such as a pattern image, a marker image, and a content image.

The pattern image includes a plurality of feature points indicating coordinates on an image to be projected from projector 20 onto projection surface 40. Specifically, the pattern image includes, for example, a plurality of (about 1000) feature points in a region of the projection image projected by projector 20. The pattern image can be used to identify a correspondence between coordinates of an optical element (such as a DMD or a liquid crystal element) for image display of projector 20 and coordinates of an optical element (such as an imaging sensor) for image acquisition of imaging device 30. Specifically, in the pattern image, a plurality of feature points are regularly arranged. As a result, each feature point is displayed in a state in which each feature point can be uniquely grasped by the projection of the pattern image, and thus, it can be used for the correspondence between the coordinates of the projection image output by projector 20 and the coordinates of the captured image acquired by imaging device 30.

The marker image is a marker image displayed by projector 20. The marker image includes a plurality of projection reference markers indicating specific coordinates defined as marks on an image to be projected by projector 20 onto projection surface 40. For example, the marker image is an image including a projection reference marker in an image display area projected by projector 20. The marker image may be used to identify a correspondence between coordinates of an optical element for image display of projector 20 and coordinates of projection surface 40. For example, the projection reference markers are disposed at four corner portions of projection surface 40. Also, if projection surface 40 includes a curved surface, the number of the projection reference markers disposed on projection surface 40 are increased depending on the curvature. Specifically, the projection reference markers may be positioned at equal intervals, such as equal halves, equal triples, or any point at a distance on the projection surface, in the lateral and longitudinal directions of the projection surface.

Arithmetic device 11 executes various types of processing such as projection processing, image acquisition processing, coordinate acquisition processing, feature point extraction processing, coordinate correspondence processing, generation processing, adjustment processing, reception processing, determination processing, and output processing.

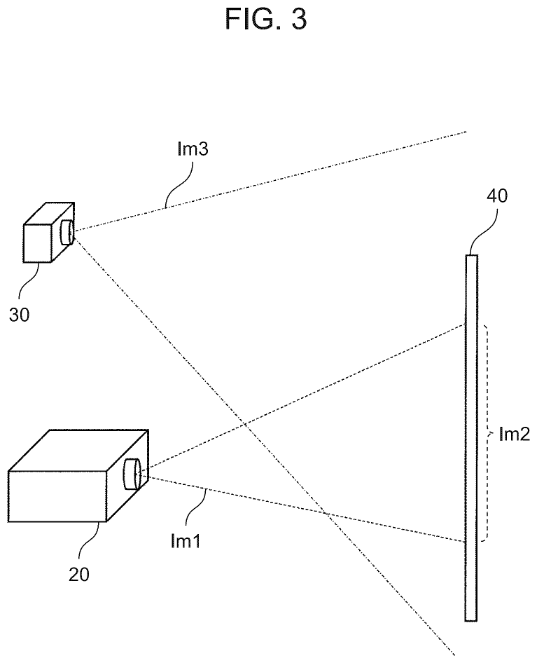

In the projection processing, arithmetic device 11 reads the pattern image out of image information 131 stored in storage 13, and causes projector 20 to project the pattern image on projection surface 40. As described above, as illustrated in FIG. 3, the image output from projector 20 to projection surface 40 in the projection processing is “projection image Im1”, and the image projected on projection surface 40 is “projection surface image Im2”. Thereafter, the image captured by imaging device 30 is “captured image Im3”.

In the image acquisition processing, arithmetic device 11 acquires first captured image data 132 including the pattern image projected on projection surface 40, which is the captured image of imaging device 30, from imaging device 30. In addition, arithmetic device 11 stores acquired first captured image data 132 in storage 13.

In the coordinate acquisition processing, arithmetic device 11 acquires the coordinates of the feature point on projection surface 40 included in first captured image data 132, and stores the acquired coordinates of each feature point as feature point coordinate data 133 in storage 13 in association with first captured image data 132. Specifically, arithmetic device 11 acquires coordinates matching the condition indicating the feature point, and generates data including the plurality of acquired coordinates as feature point coordinate data 133.

In the feature point extraction processing, arithmetic device 11 compares the feature point included in first captured image data 132 with each feature point included in the pattern image, and extracts a “non-projected feature point” which is a feature point not to be projected on projection surface 40. In the feature point extraction processing, arithmetic device 11 compares the feature point included in first captured image data 132 with each feature point included in the pattern image, and extracts a “projected feature point” which is a feature point projected on projection surface 40. Specifically, arithmetic device 11 compares the coordinates of each feature point included in feature point coordinate data 133 acquired by the coordinate acquisition processing with the coordinates of each feature point of the pattern image, and determines whether the feature point corresponding to each feature point of the pattern image is included on projection surface 40 of first captured image data 132. When the feature point corresponding to the feature point of the pattern image is included on projection surface 40 of first captured image data 132, arithmetic device 11 sets the feature point as a “projected feature point”. On the other hand, when the feature point corresponding to the feature point of the pattern image is not included on projection surface 40 of first captured image data 132, arithmetic device 11 sets the feature point as a “non-projected feature point”. In other words, among the feature points included in the pattern image, the feature point projected on projection surface 40 is referred to as a “projected feature point”. On the other hand, among the feature points included in the pattern image, the feature point not to be projected on projection surface 40 is referred to as a “non-projected feature point”. Note that arithmetic device 11 adds the result of the feature point extraction processing to feature point coordinate data 133 stored in storage 13.

In the coordinate correspondence processing, arithmetic device 11 associates the coordinates of each feature point of the pattern image projected by projector 20, the coordinates of each feature point of the pattern image projected on projection surface 40, and the coordinates of each feature point captured by imaging device 30. For example, arithmetic device 11 stores the correspondence relationship among the coordinates of the projected feature point on projection image Im1, the coordinates of the projected feature point on projection surface image Im2, and the coordinates of the projected feature point on captured image Im3 in feature point coordinate data 133 in storage 13. By using these correspondence relationships, it is possible to indicate how an image output from projector 20 is represented on projection surface 40.

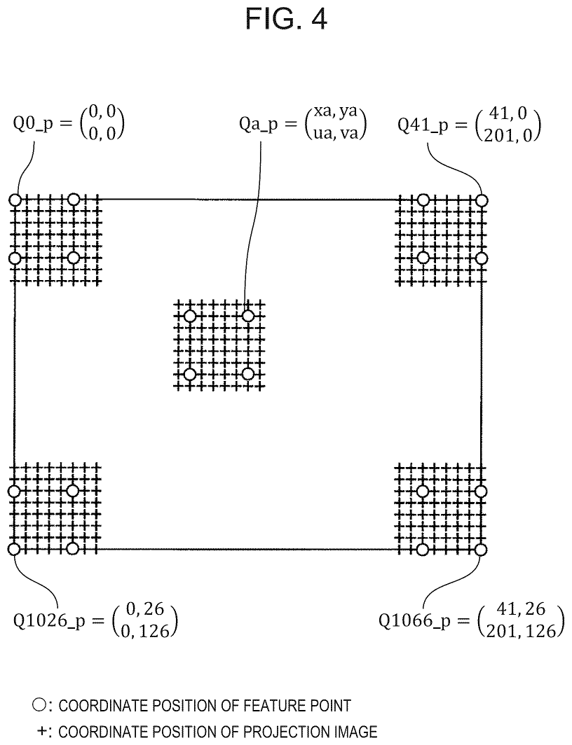

An example of the coordinate correspondence processing will be described with reference to FIG. 4. FIG. 4 illustrates an example in which 41×26 feature points are provided in the pattern image as a source of generation of projection image Im1, and the number of coordinates of projection image Im1 projected from projector 20 is 201×126. In FIG. 4, for simplification of the drawing, illustration of all coordinates and feature points is omitted. For example, a relationship between coordinates (xa, ya) of arbitrary feature point a of the pattern image and coordinates (ua, va) corresponding to feature point a on projection image Im1 in a case where the pattern image is projected on the projection surface by projector 20 is expressed by the following equation (1). The relationship between the coordinates of the pattern image and the coordinates of projection image Im1 is uniquely defined for each of the test pattern image and the projection image.

$$\begin{matrix}[ Math . 1 ] & \\ {Q}_{a \_ p} = ( \begin{matrix}xa , ya \\ ua , va\end{matrix} ) & ( 1 )\end{matrix}$$

For example, relationship Q_{0_p} between coordinates (0,0) at the uppermost part of the left end in the pattern image and the corresponding coordinates on projection image Im1, relationship Q_{41_p} between coordinates (41,0) at the uppermost part of the right end in the pattern image and the corresponding coordinates on projection image Im1, relationship Q_{1026_p} between coordinates (0,26) at the lowermost part of the left end in the pattern image and the corresponding coordinates on projection image Im1, and relationship Q_{1066_p} between coordinates (41,26) at the lowermost part of the right end in the pattern image and the corresponding coordinates on projection image Im1 can be defined by the following formulae (1-1) to (1-4), respectively.

$$\begin{matrix}[ Math . 2 ] & \\ {Q}_{0 \_ p} = ( \begin{matrix}0 , 0 \\ 0 , 0\end{matrix} ) & ( 1 - 1 )\end{matrix}$$

$${Q}_{41 \_ p} = ( \begin{matrix}41 , 0 \\ 201 , 0\end{matrix} ) \qquad ( 1 - 2 )$$

$${Q}_{1026 \_ p} = ( \begin{matrix}0 , 26 \\ 0 , 126\end{matrix} ) \qquad ( 1 - 3 )$$

$${Q}_{1066 \_ p} = ( \begin{matrix}41 , 26 \\ 201 , 126\end{matrix} ) \qquad ( 1 - 4 )$$

In addition, the relationship between coordinates (xa, ya) of arbitrary feature point a of the pattern image and coordinates (sa, ta) corresponding to coordinates (xa, ya) of feature point a on captured image Im3 obtained by imaging device 30 capturing projection surface image Im2 projected on projection surface 40 by projector 20 is expressed by the following formula (2). The relationship between the coordinates of the pattern image and the coordinates of projection surface image Im2 on projection surface 40 is determined according to the shape of projection surface image Im2 on projection surface 40 and the capturing view angle formed by projection surface 40 and imaging device 30 that captures projection surface 40.

$$\begin{matrix}[ Math . 3 ] & \\ {Q}_{a \_ c} = ( \begin{matrix}xa , ya \\ sa , ta\end{matrix} ) & ( 2 )\end{matrix}$$

Furthermore, the relationship between coordinates (ua, va) on projection image Im1 corresponding to coordinates (xa, ya) of feature point a of the pattern image and coordinates (sa, ta) corresponding to coordinates (xa, ya) of feature point a on captured image Im3 obtained by capturing projection surface image Im2 on projection surface 40 can be expressed by the following formula (3).

$$\begin{matrix}[ Math . 4 ] & \\ {T}_{a \_ pc} = ( \begin{matrix}ua , va \\ sa , ta\end{matrix} ) & ( 3 )\end{matrix}$$

Formula (3) is a coordinate conversion matrix from the coordinates of projection image Im1 to the coordinates of captured image Im3. Therefore, by using coordinate conversion matrix T_{a_pc}, the coordinates of an arbitrary feature point can be obtained from the coordinates of projection image Im1 to the coordinates of captured image Im3, or vice versa, the coordinates of projection image Im1 can be obtained from the coordinates of captured image Im3.

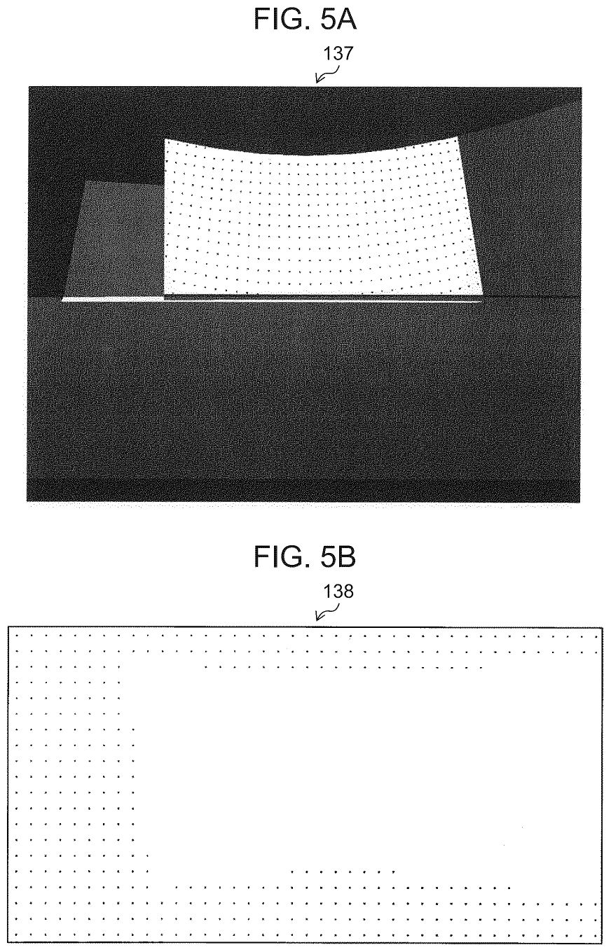

In the generation processing, arithmetic device 11 generates projected feature point data 137 in which the plurality of projected feature points extracted in the extraction processing are arranged at the corresponding positions on projection surface 40 captured by imaging device 30. Specifically, arithmetic device 11 generates projected feature point data 137 in which the mark indicating the feature point is arranged at the position corresponding to the projected feature point on projection surface 40 of the image data indicating the state of being captured by imaging device 30 using feature point coordinate data 133. FIG. 5A illustrates an example of projected feature point data 137. For example, by referring to projected feature point data 137, it is possible to grasp the proportion of the image data projected from projector 20 onto projection surface 40. Specifically, when the number of projected feature points that can be confirmed by projected feature point data 137 is extremely smaller than the number of feature points included in the actual pattern image, it is considered that the image data projected from projector 20 is too large with respect to projection surface 40. In this case, for example, the number of feature points, the number of projected feature points, the ratio of the number of projected feature points to the number of feature points, and the like may be displayed together. Furthermore, for example, by referring to projected feature point data 137, it is possible to grasp how the image data to be projected from projector 20 is distorted and projected. Specifically, in projected feature point data 137, it is preferable that the feature points are uniformly dispersed and arranged on projection surface 40. However, in a case where the feature points are densely arranged in a part, it can be grasped that the feature points are distorted in the part.

In the generation processing, arithmetic device 11 generates non-projected feature point data 138 in which the plurality of non-projected feature points extracted in the extraction processing are arranged at the corresponding positions in the range of the projection image projected by projector 20. Specifically, arithmetic device 11 generates non-projected feature point data 138 in which the mark indicating the feature point is disposed at the position corresponding to the non-projected feature point in the region of the image data indicating the state of being projected by projector 20 using feature point coordinate data 133. FIG. 5B illustrates an example of non-projected feature point data 138. For example, by referring to non-projected feature point data 138, it is possible to grasp, of the image data projected from projector 20, what percentage is projected and what percentage is not projected, and how the image data is projected in a distorted manner. Specifically, it is conceivable that the image data projected from projector 20 is too large with respect to projection surface 40 as the range in which the non-projected feature points that can be confirmed by non-projected feature point data 138 exist is greater. In this case, for example, the number of feature points, the number of non-projected feature points, the ratio of the number of non-projected feature points to the number of feature points, and the like may be displayed together.

In the projection processing, arithmetic device 11 reads the marker image from image information 131 stored in storage 13, and causes projector 20 to project the marker image on projection surface 40.

In addition, in the image acquisition processing, arithmetic device 11 acquires, from imaging device 30, second captured image data 134 including the marker image projected onto projection surface 40 on which the plurality of disposition reference markers respectively corresponding to the plurality of projection reference markers are disposed. The disposition reference marker is a mark that a user can dispose at a desired position on projection surface 40.

In addition, in the generation processing, arithmetic device 11 generates coordinate conversion table 135 for projecting the non-projected feature point onto projection surface 40 using the result of comparison between the positions of the plurality of disposition reference markers included in second captured image data 134 and the positions of the plurality of projection reference markers. In other words, by using coordinate conversion table 135, each coordinate of the image data can be converted into each coordinate of the projection surface to perform geometric correction in order to cause projector 20 to project the image data onto projection surface 40. Specifically, arithmetic device 11 generates coordinate conversion table 135 that associates the coordinate system of projector 20 with the coordinate system of projection surface 40. Arithmetic device 11 stores generated coordinate conversion table 135 in storage 13.

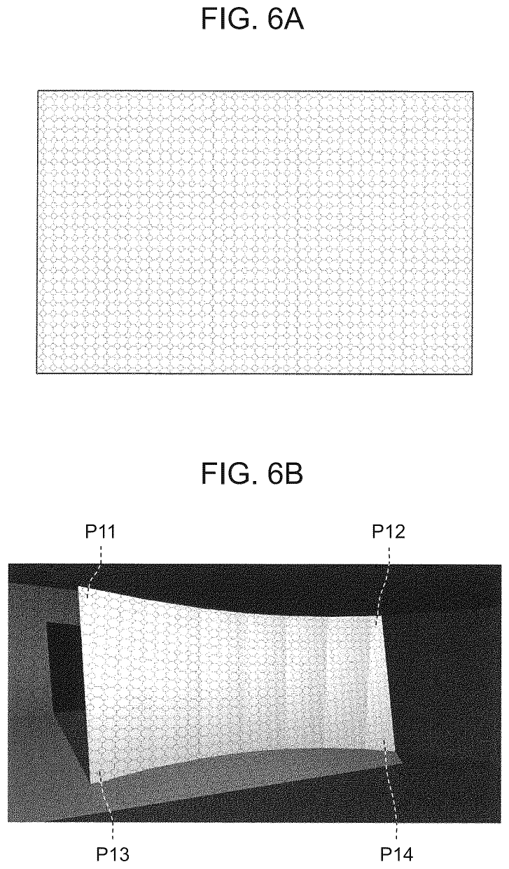

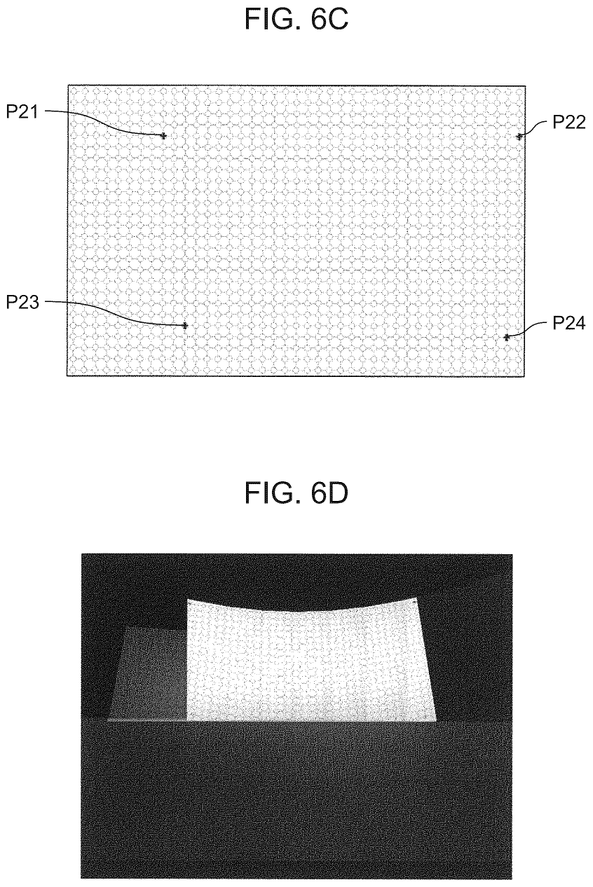

An example of generating coordinate conversion table 135 will be described with reference to FIGS. 6A to 6D. FIG. 6A illustrates an example of a pattern image including a total of 41×26 feature points, in which 41 points are in the horizontal direction and 26 points are in the vertical direction. FIG. 6B is an external view illustrating a state in which the disposition reference marker is disposed on projection surface 40 on which the pattern image illustrated in FIG. 6A is projected. The user arranges the disposition reference markers at at least four points or more on projection surface 40 so as to indicate the projection range by projector 20 and the desired range. In the example illustrated in FIG. 6B, the disposition reference markers are disposed at four points (P11 to P14) on the upper left side, upper right side, lower left side, and lower right side of projection surface 40, respectively. In the pattern image, points corresponding to respective points (P11 to P14) of the disposition reference markers illustrated in FIG. 6B are four points (P21 to P24) illustrated in FIG. 6C. Accordingly, the position of each projection reference marker projected from projector 20 is uniquely determined. As illustrated in FIG. 6B, projection surface 40 is captured by imaging device 30 in a state where the disposition reference marker is disposed, and each feature point of the pattern image in captured image Im3 is detected, so that the feature point of projection image Im1 can be calculated, and thus, the position of the disposition reference marker in captured image Im3 can be uniquely obtained. Since the range in which the user expects projection is a range surrounded by the disposition reference markers, the positions of the respective disposition reference markers are complemented with the positions of the feature points included in captured image Im3 on the basis of the feature points included in captured image Im3 and the feature points not included in captured image Im3 to generate coordinate conversion table 135.

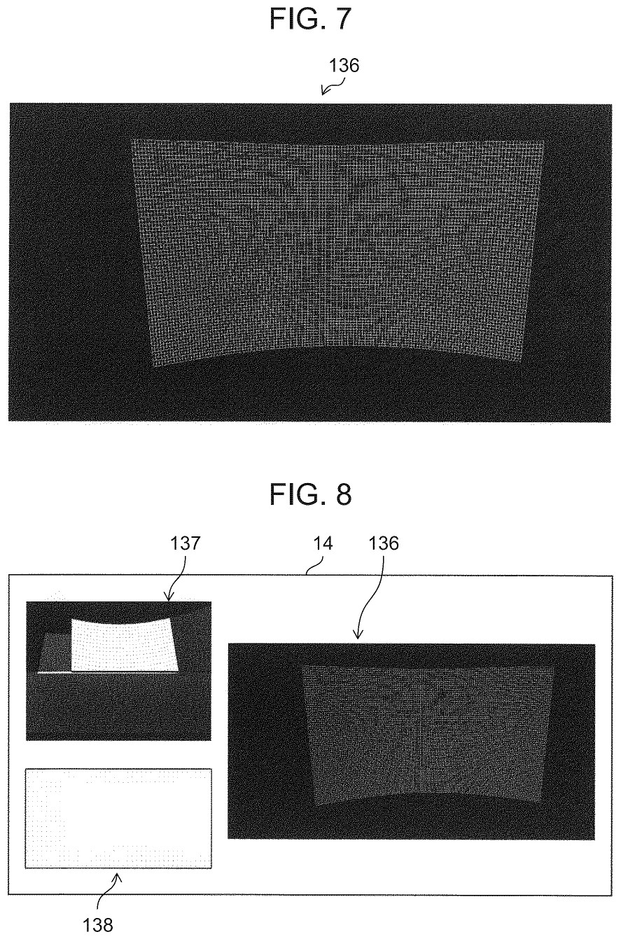

In addition, in the generation processing, arithmetic device 11 generates visualized image data 136 obtained by visualizing the projected feature points and the non-projected feature points using coordinate conversion table 135. FIG. 7 illustrates an example of visualized image data 136. In visualized image data 136 illustrated in FIG. 7, an outer frame indicates a projectable range of projector 20. For example, it is assumed that a predetermined grid is set in image data to be projected. At this time, in visualized image data 136 illustrated in FIG. 7, each grid line of the image data to be projected is each curve in gray in the projection image. Since the range that can be projected by projector 20 is wider than the area of projection surface 40, as illustrated in FIG. 7, the projection image is deformed using coordinate conversion table 135 such that the image data of the projection target is contained in a part thereof. Note that, in projection system 1, since an image may be projected so as to protrude from projection surface 40, the outer frame of the portion indicated in gray does not necessarily coincide with projection surface 40.

In the output processing, as illustrated in FIG. 8, arithmetic device 11 may generate result data including projected feature point data 137, non-projected feature point data 138, and visualized image data 136, and display the result data on display 14.

In the adjustment processing, arithmetic device 11 may use coordinate conversion table 135 to adjust the image data such that the entire image data is projected onto projection surface 40. Further, arithmetic device 11 may cause projector 20 to project the adjusted image data onto projection surface 40 in the projection processing. Note that the image data generated in the adjustment processing may be a pattern image in addition to the content image to be projected in projection system 1. The pattern image is displayed again, and it is easy to determine whether the generated coordinate conversion table 135 is appropriate.

In the reception processing, arithmetic device 11 receives designation of a predetermined display range. For example, arithmetic device 11 can receive the number of pixels indicating a predetermined range from the periphery on the basis of the number of pixels of the projection image to be projected by projector 20, and define the range designated by the received number of pixels as the display range.

The “determination of the display range” is a determination as to whether the entire image or a desired range of the image is projected on projection surface 40. For example, in projection system 1, in projector 20, a predetermined pixel shift may occur in the longitudinal direction and the lateral direction of the image due to the characteristics of the apparatus. On the other hand, in image processor 10, by determining a display range in consideration of a possible deviation amount due to characteristics of the apparatus in advance and determining whether the image is displayed within the range, the entire range of the image can be set to be displayed on projection surface 40 even if the deviation occurs.

In addition, arithmetic device 11 receives designation of the deformation condition in the reception processing. For example, arithmetic device 11 can determine the degree of deformation of each coordinate with respect to the original image as the deformation condition. Specifically, arithmetic device 11 can receive an allowable angle (for example, 10°) for each of the x direction and the y direction, and determine movement within the angle as the deformation condition for coordinates. Furthermore, for example, a maximum distance between adjacent pixels can be determined, and the maximum distance can be determined as the deformation condition.

“Determination of deformation condition” is a determination as to whether an image to be projected on projection surface 40 can be changed. For example, in projection system 1, when projector 20 deforms and projects an image on projection surface 40 that is not a flat surface such as a curved surface, projector 20 may not be able to deform the image to be fit with conformity with projection surface 40 depending on the degree of curvature due to the characteristics of the apparatus. On the other hand, whether or not the image can be appropriately deformed can be physically grasped in advance. Therefore, image processor 10 can perform setting such that an image is displayed on projection surface 40 by determining whether deformation is possible. For example, by changing the disposition position of projector 20, the angle between projector 20 and projection surface 40 can be changed, and an image can be displayed on projection surface 40. Alternatively, an image can be displayed on projection surface 40 by changing the projection view angle of the lens of projector 20.

In the determination processing, arithmetic device 11 determines whether or not the display using coordinate conversion table 135 is display within a predetermined display range allowed for coordinate conversion. In addition, in the determination processing, arithmetic device 11 determines whether or not the display using coordinate conversion table 135 satisfies a predetermined deformation condition under which deformation of the image is allowed. Furthermore, arithmetic device 11 can output the determination result in the output processing. For example, in a case where the determination result does not satisfy the deformation condition, the shape of the projection surface, the disposition of the projector, and/or the projection lens can be changed as described above, and adjustment can be performed so as to satisfy the deformation condition.

### <<Inspection Method>>

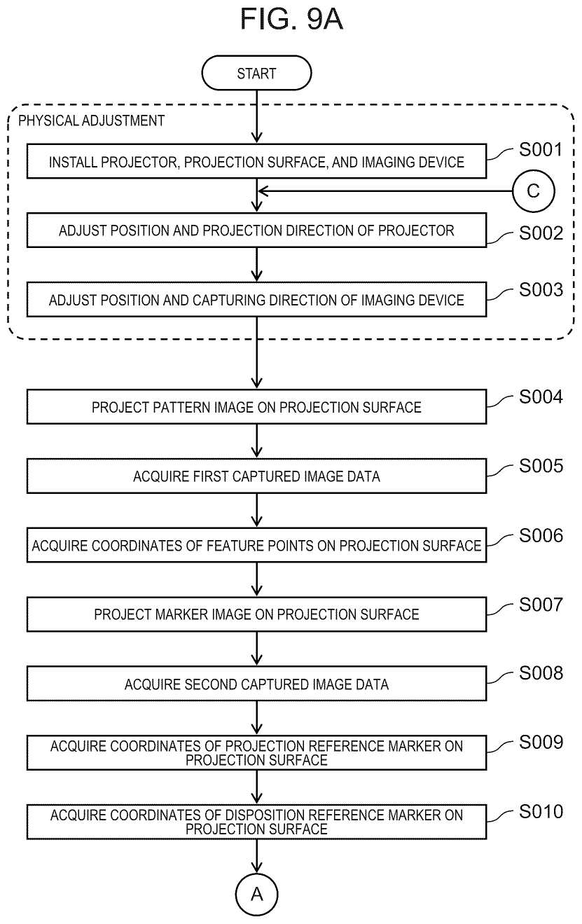

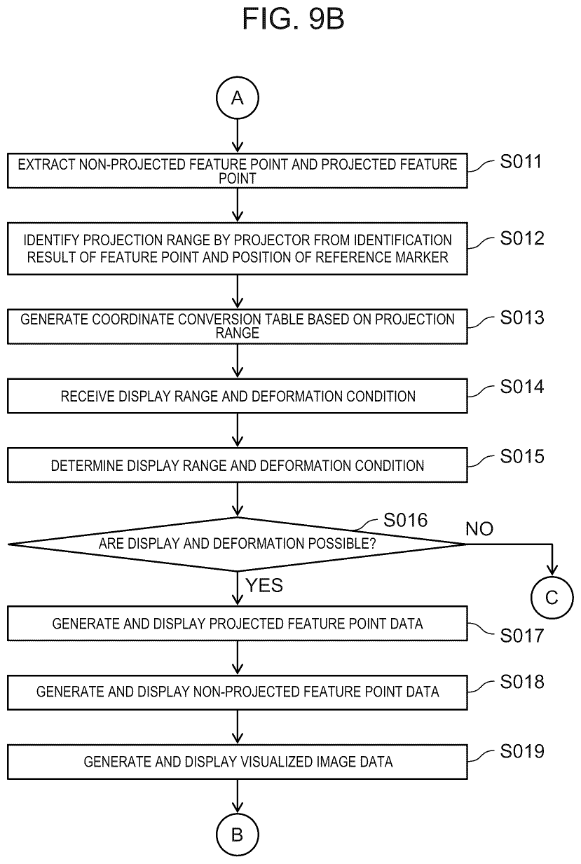

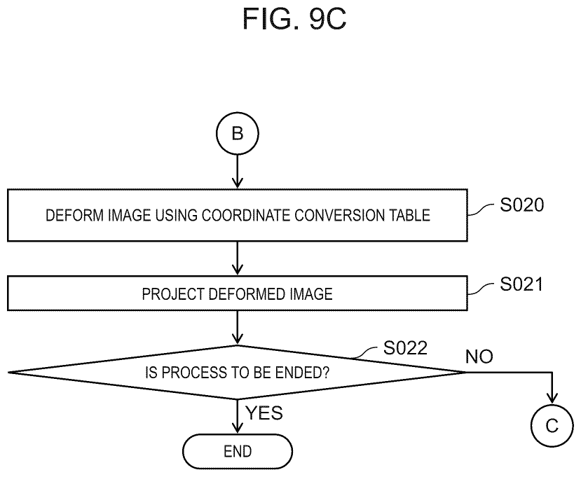

An inspection method according to the present exemplary embodiment will be described with reference to flowcharts shown in FIGS. 9A to 9C.

First, a user (S001) installs projector 20, projection surface 40, and imaging device 30 in a space.

Further, the position of projector 20 is adjusted (S002). Specifically, in addition to the disposition position on the three-dimensional space in consideration of the relationship between the space, projection surface 40, and the like, the projection direction is considered, and the position of projector 20 is adjusted such that an image is projected from projector 20 onto entire projection surface 40.

Subsequently, the position of imaging device 30 is adjusted (S003). Specifically, in addition to the disposition position on the three-dimensional space in consideration of the relationship between the space, projector 20, projection surface 40, and the like, the capturing direction is considered, and the position of imaging device 30 is adjusted such that entire projection surface 40 can be captured. The processing in steps S001 to S003 is physical adjustment.

When the physical adjustment is completed, arithmetic device 11 operates projector 20 to project the pattern image on projection surface 40 (S004). The pattern image includes a plurality of feature points.

Arithmetic device 11 acquires first captured image data 132 from imaging device 30 (S005). First captured image data 132 includes a pattern image projected from projector 20 onto projection surface 40.

Arithmetic device 11 acquires the coordinates of the plurality of feature points projected on projection surface 40 from first captured image data 132 acquired in step S005 (S006).

Subsequently, arithmetic device 11 operates projector 20 to project the marker image on projection surface 40 (S007). The marker image includes a projection reference marker to transform the projection image into a desired shape.

Arithmetic device 11 acquires second captured image data 134 from imaging device 30 (S008). Second captured image data 134 includes a marker image projected from projector 20 onto projection surface 40.

Arithmetic device 11 acquires the coordinates of the plurality of projection reference markers projected on projection surface 40 from second captured image data 134 acquired in step S008 (S009).

Arithmetic device 11 acquires the coordinates of the plurality of disposition reference markers disposed on projection surface 40 from second captured image data 134 acquired in step S008 (S010).

Arithmetic device 11 extracts the non-projected feature point and the projected feature point using the pattern image and the acquisition result of step S006 (S011). Specifically, the coordinates of each feature point included in the pattern image are compared with each feature point acquired in step S006 to obtain a corresponding feature point, the feature point extracted in step S006 is set as a projected feature point, and a feature point that is not extracted is set as a non-projected feature point.

Using the coordinates of the disposition reference marker in step S010 and the extraction result in step S011, arithmetic device 11 specifies a projection range in which the projection image is projected from projector 20 (S012).

Based on the projection range specified in step S012, arithmetic device 11 generates coordinate conversion table 135 that transforms the projection image projected from projector 20 according to the shape of projection surface 40 (S013).

Arithmetic device 11 receives the display range and the deformation condition (S014).

Arithmetic device 11 determines whether or not the image deformed by coordinate conversion table 135 generated in step S013 satisfies the display range and the deformation condition received in step S014 (S015). When the image is not displayed within the display range and/or when the deformation condition is not satisfied (NO in S016), arithmetic device 11 returns the process to step S002 and repeats the processing of steps S003 to S015.

Thereafter, arithmetic device 11 generates, and displays on display 14, projected feature point data 137 in which the projected feature points are arranged (S017).

In addition, arithmetic device 11 generates, and displays on display 14, non-projected feature point data 138 in which the non-projected feature points are arranged (S018).

Further, arithmetic device 11 generates visualized image data 136 using the coordinate conversion table and displays visualized image data 136 on display 14 (S019).

In addition, arithmetic device 11 deforms the image using coordinate conversion table 135 generated in step S013 (S020).

Arithmetic device 11 operates projector 20 to project the image deformed in step S020 onto projection surface 40 (S021).

When the image projected on projection surface 40 is as expected, termination is operated, and a series of processing related to inspection in projection system 1 is terminated (YES in S022).

On the other hand, when the image projected on projection surface 40 is not as expected (NO in S022), the process returns to step S002 since readjustment is necessary, and the processing of steps S002 to S022 is repeated. Specifically, after physical adjustment of projector 20 and imaging device 30 is executed, the inspection processing is executed again.

As described above, projection system 1 according to the first exemplary embodiment makes it possible to confirm information generated in the processing of automatic geometric correction. Accordingly, it is possible to facilitate determination of validity of the geometric correction by the projector.

### Second Exemplary Embodiment

According to the image processor according to the second exemplary embodiment, even in a state where the projection system does not actually exist, such as a case where the projection system is not yet constructed, it is possible to inspect the projection of the image by the projector to be installed and the automatic geometric correction by assuming the space in which the projection system is installed using the virtual space information and the parameter information including the disposition positions of the projector, the projection surface, the imaging device, and the like to be installed. For example, in a situation where a projector, a projection surface, an imaging device, and the like are already installed in a space, the projector can be used for adjusting the position of the projector and the like in the space. Furthermore, for example, in a situation where the projector or the like is not installed in the space, it can be used to determine the disposition or the like of the projector or the like in the space. Note that, in the following, an example will be described in which inspection is performed in a situation where the projection system is not yet constructed and the projector, the projection surface, and the imaging device are not disposed in the space. However, the same applies to a case where a virtual space is generated and inspection is performed in a case where the projector or the like exists in the real space.

### <<Image Processor>>

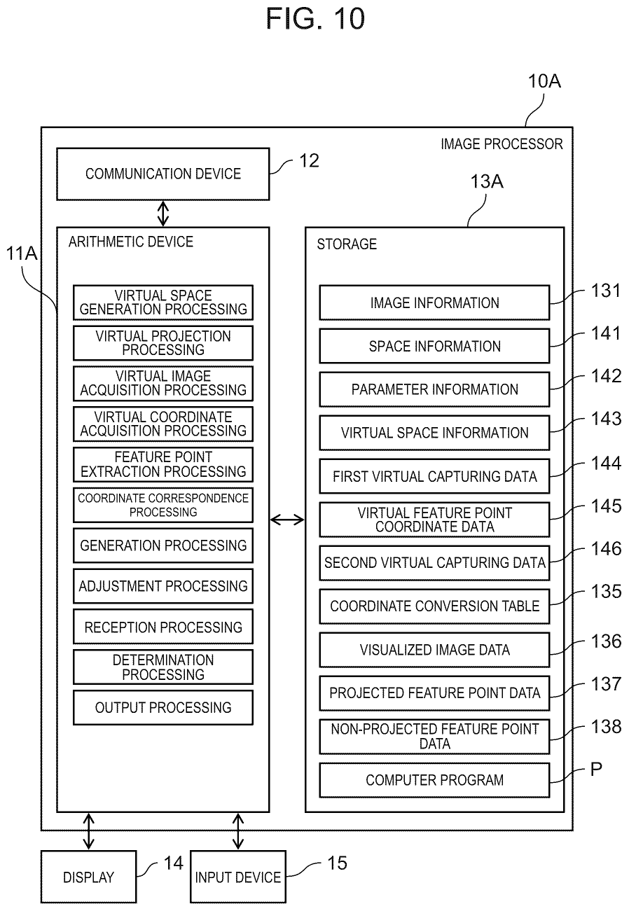

As illustrated in FIG. 10, image processor 10A according to the second exemplary embodiment is an information processor including arithmetic device 11A, communication device 12, storage 13A, and the like. Furthermore, image processor 10A can be connected to display 14 and input device 15. The configurations of communication device 12, display 14, and input device 15 are the same as those described above with reference to FIG. 1.

As illustrated in FIG. 10, storage 13A of image processor 10A is different from storage 13 of image processor 10 described above with reference to FIG. 1 in that first captured image data 132, feature point coordinate data 133, and second captured image data 134 are not stored, but space information 141, parameter information 142, virtual space information 143, first virtual capturing data 144, virtual feature point coordinate data 145, and second virtual capturing data 146 are stored.

space information 141 is information regarding a real space in which the projector and the like are scheduled to be disposed. For example, space information 141 can include at least one of disposition positions of the projector and the projection surface in the space, material information and a size of the projection surface, disposition position of the imaging device in the space, information regarding a size of the space, information regarding a building material constituting the space, information regarding lighting used in the space, and information regarding an object disposed in the space. For example, the space information is coordinate information indicating a space, coordinate information including a disposition position related to an object disposed in the space, and information indicating a specification of the object.

Parameter information 142 may include a parameter value set for a projector to be connected to image processor 10. For example, parameter information 142 can include at least one of the resolution, the luminance, the chromaticity, the zoom of the lens, the shift amount, and the slow ratio set for the projector. Furthermore, parameter information 142 may include a parameter value set to the imaging device. For example, parameter information 142 can include at least one of a focal length, an exposure, and an angle of view set in an imaging device to be connected to image processor 10.

Virtual space information 143 is information indicating the virtual space generated on the basis of space information 141 in image processor 10A. In virtual space information 143, a virtual parameter value based on parameter information 142 is set to the virtual display and the virtual imaging device disposed on the basis of space information 141. Virtual space information 143 is information including coordinate information and the like represented by space information 141, virtual parameter values, and the like.

Arithmetic device 11A executes various types of processing such as virtual space generation processing, virtual projection processing, virtual image acquisition processing, virtual coordinate acquisition processing, feature point extraction processing, coordinate correspondence processing, generation processing, adjustment processing, reception processing, determination processing, and output processing.

In the virtual space generation processing, arithmetic device 11A reads space information 141 stored in storage 13, and generates virtual space information 143 indicating the virtual space in which the virtual projector, the virtual projection surface, and the virtual imaging device are disposed.

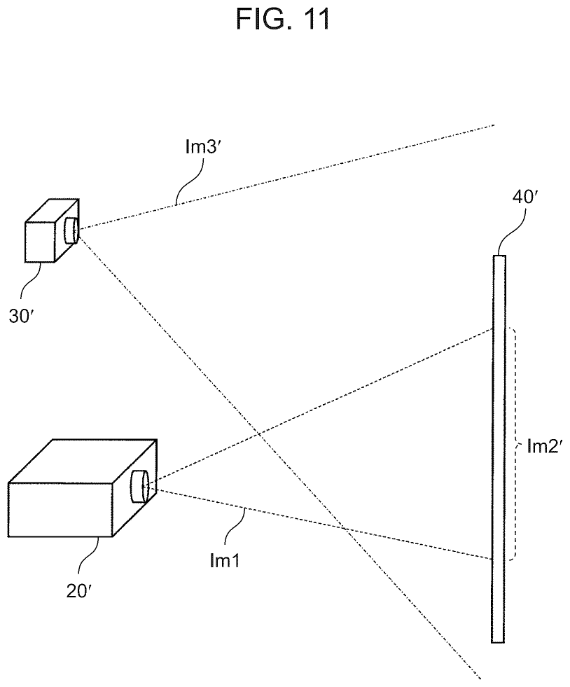

In the virtual projection processing, arithmetic device 11A uses the pattern image included in image information 131, parameter information 142, and virtual space information 143 to project the pattern image from the virtual projector disposed in the virtual space indicated by virtual space information 143 onto the virtual projection surface. For example, as illustrated in FIG. 11, an image output from virtual projector 20′ to virtual projection surface 40′ in the virtual projection processing is a “projection image Im1”, and an image in a state of being projected on virtual projection surface 40′ is a “virtual projection surface image Im2′”. Thereafter, an image captured by virtual imaging device 30′ in the virtual space is a “virtual captured image Im3′”.

In the virtual image acquisition processing, arithmetic device 11A uses parameter information 142 and virtual space information 143 to acquire first virtual capturing data 144 including the pattern image projected on virtual projection surface 40′ from virtual imaging device 30′ in the virtual space indicated by virtual space information 143. In addition, arithmetic device 11A stores acquired first virtual capturing data 144 in storage 13A.

In the virtual coordinate acquisition processing, arithmetic device 11A acquires the coordinates of the feature point on virtual projection surface 40′ included in first virtual capturing data 144, associates the acquired coordinates of each feature point with first virtual capturing data 144, and stores virtual feature point coordinate data 145 in storage 13A.

In the feature point extraction processing, arithmetic device 11A compares the feature point included in first virtual capturing data 144 with each feature point included in the pattern image, and extracts a non-projected feature point that is not to be projected on virtual projection surface 40′. Furthermore, in the feature point extraction processing, arithmetic device 11A compares the feature point included in first virtual capturing data 144 with each feature point included in the pattern image, and extracts a projected feature point that is projected on virtual projection surface 40′. Specifically, arithmetic device 11A compares the coordinates of each feature point included in virtual feature point coordinate data 145 acquired in the virtual coordinate acquisition processing with the coordinates of each feature point of the pattern image, and determines whether each feature point of the pattern image is included on virtual projection surface 40′ of first virtual capturing data 144. When first virtual capturing data 144 is included on virtual projection surface 40′, arithmetic device 11A sets the feature point as a “projected feature point”. On the other hand, when first virtual capturing data 144 is not included on virtual projection surface 40′, arithmetic device 11 sets the feature point as a “non-projected feature point”. In other words, among the feature points included in the pattern image, the feature point projected on virtual projection surface 40′ is referred to as a “projected feature point”. On the other hand, among the feature points included in the pattern image, the feature point not to be projected on virtual projection surface 40′ is referred to as a “non-projected feature point”. Note that arithmetic device 11A adds the result of the feature point extraction processing to virtual feature point coordinate data 145 stored in storage 13A.

In the coordinate correspondence processing, arithmetic device 11A associates the coordinates of each feature point of the pattern image projected by virtual projector 20′, the coordinates of each feature point of the pattern image projected on virtual projection surface 40′, and the coordinates of each feature point captured by virtual imaging device 30′. For example, arithmetic device 11A stores the correspondence among the coordinates of the projected feature point and the non-projected feature point on projection image Im1, the coordinates of the projected feature point on the virtual projection surface image Im2′, and the coordinates of the projected feature point on the virtual captured image Im3′ in virtual feature point coordinate data 145 of storage 13A. Note that arithmetic device 11A executes the coordinate correspondence processing as described above with reference to FIG. 4.

In the generation processing, arithmetic device 11A generates projected feature point data 137 in which the plurality of projected feature points extracted in the extraction processing are arranged at the corresponding positions on virtual projection surface 40′ imaged by virtual imaging device 30′.

In the generation processing, arithmetic device 11A generates non-projected feature point data 138 in which the plurality of non-projected feature points extracted in the extraction processing is arranged at the corresponding positions in the range of the virtual projection image projected by virtual projector 20′.

Furthermore, in the virtual projection processing, arithmetic device 11A uses the marker image included in image information 131, parameter information 142, and virtual space information 143 to project the marker image from virtual projector 20′ indicated by virtual space information 143 onto virtual projection surface 40′.

In addition, in the virtual image acquisition process, arithmetic device 11A uses parameter information 142 and virtual space information 143 to acquire, from virtual imaging device 30′ in the virtual space indicated by virtual space information 143, second virtual capturing data 146 including the marker image projected on virtual projection surface 40′ on which the plurality of projection reference markers and the plurality of disposition reference markers respectively corresponding to the plurality of projection reference markers are disposed. In addition, arithmetic device 11A stores acquired second virtual capturing data 146 in storage 13A.

In addition, in the generation processing, arithmetic device 11A generates coordinate conversion table 135 for projecting the non-projected feature point onto virtual projection surface 40′ using the result of comparison between the positions of the plurality of disposition reference markers included in second virtual capturing data 146 and the positions of the plurality of projection reference markers. Since the virtual space simulates a real space, image data can be projected from projector 20 onto projection surface 40 in the real space corresponding to the virtual space by using coordinate conversion table 135 generated here.

In addition, in the generation processing, arithmetic device 11A generates visualized image data 136 obtained by visualizing the projected feature points and the non-projected feature points using coordinate conversion table 135.

Furthermore, in the adjustment processing, arithmetic device 11A may use coordinate conversion table 135 to adjust the image data such that the entire image data is projected on virtual projection surface 40′. As described above, the image data adjusted by coordinate conversion table 135 can be projected on virtual projection surface 40′ and can also be projected on projection surface 40.

Furthermore, arithmetic device 11A may cause virtual projector 20′ to project the adjusted image data on virtual projection surface 40′ in the virtual projection processing. Specifically, arithmetic device 11A can generate a virtual space in which desired image data is projected on virtual projection surface 40′ by projecting the generated adjusted image data. Furthermore, arithmetic device 11A can display the virtual captured image on display 14 and allow the user to confirm the virtual captured image.

In the reception processing, arithmetic device 11A receives designation of a predetermined display range. In addition, arithmetic device 11A receives designation of the deformation condition in the reception processing.

In the determination processing, arithmetic device 11A determines whether or not the display using coordinate conversion table 135 is display within a predetermined display range allowed for coordinate conversion. In addition, in the determination processing, arithmetic device 11A determines whether or not the display using coordinate conversion table 135 satisfies a predetermined deformation condition under which deformation of the image is allowed.

Arithmetic device 11A outputs the determination result in the output processing.

### <<Inspection Method>>

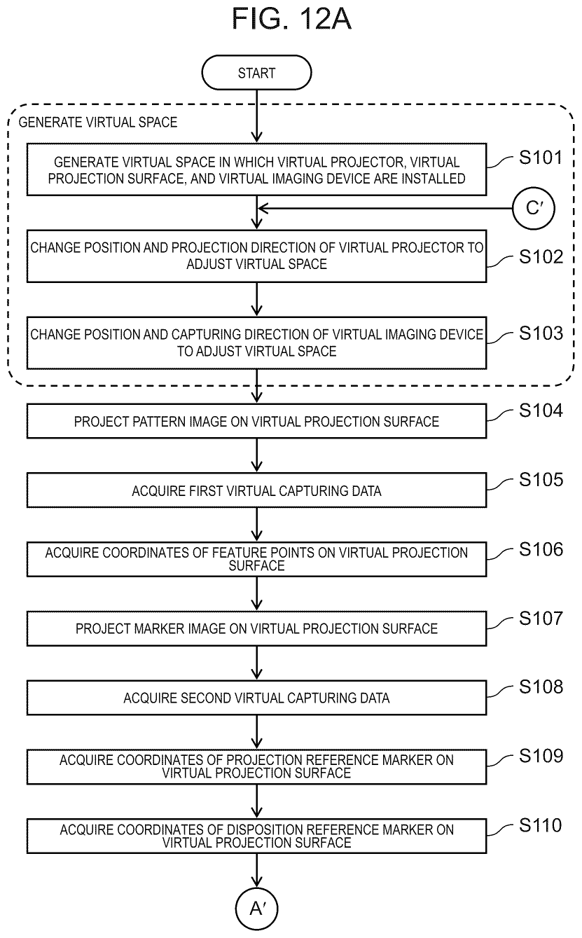

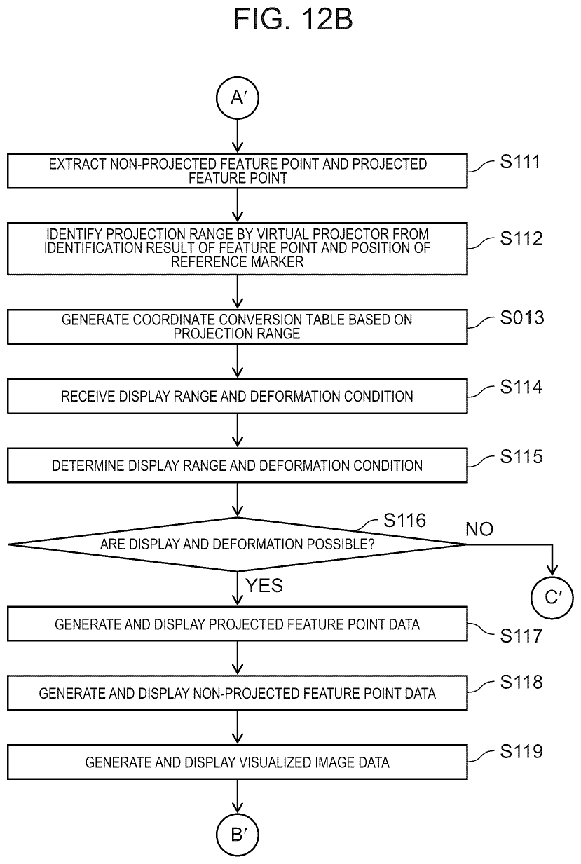

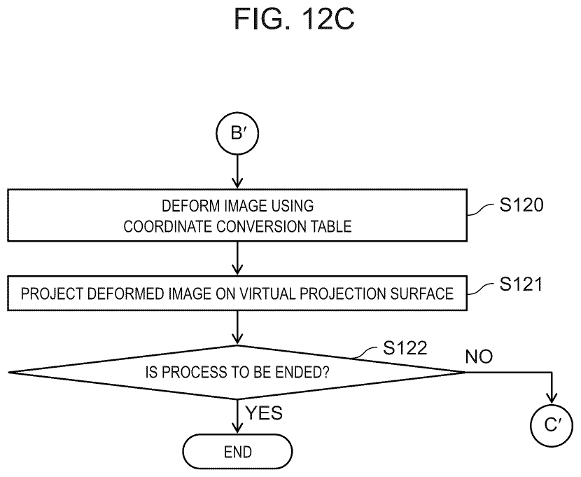

An inspection method according to the present exemplary embodiment will be described with reference to flowcharts shown in FIGS. 12A to 12C.

First, arithmetic device 11A generates virtual space information indicating a virtual space in which virtual projector 20′, virtual projection surface 40′, and virtual imaging device 30′ are installed (S101).

Furthermore, the position of virtual projector 20′ in the virtual space is adjusted (S102).

Subsequently, the position of virtual imaging device 30′ in the virtual space is adjusted (S103).

Thereafter, arithmetic device 11A causes virtual projector 20′ to project the pattern image on virtual projection surface 40′ (S104).

In addition, arithmetic device 11A acquires first virtual capturing data 144 from virtual imaging device 30′ (S105). First virtual capturing data 144 includes a pattern image projected from virtual projector 20′ onto virtual projection surface 40′.

Furthermore, arithmetic device 11A acquires coordinates of a plurality of feature points projected on virtual projection surface 40′ from first virtual capturing data 144 acquired in step S105 (S106).

Subsequently, arithmetic device 11A operates virtual projector 20′ to project the marker image on virtual projection surface 40′ (S107).

In addition, arithmetic device 11A acquires second virtual capturing data 146 virtually captured by virtual imaging device 30′ (S108). Second virtual capturing data 146 includes marker images projected from virtual projector 20′ onto virtual projection surface 40′.

Furthermore, arithmetic device 11A acquires coordinates of a plurality of projection reference markers projected on virtual projection surface 40′ from second virtual capturing data 146 acquired in step S108 (S109).

Furthermore, arithmetic device 11 acquires coordinates of a plurality of disposition reference markers disposed on virtual projection surface 40′ from second virtual capturing data 146 acquired in step S108 (S110).

Arithmetic device 11A extracts the non-projected feature point and the projected feature point using the pattern image and the acquisition result of step S106 (S011).

Using the coordinates of the disposition reference marker in step S110 and the extraction result in step S111, arithmetic device 11A specifies a projection range in which the projection image is projected from virtual projector 20′ (S112).

Arithmetic device 11A generates coordinate conversion table 135 that transforms the projection image projected from virtual projector 20′ according to the shape of virtual projection surface 40′ based on the projection range specified in step S112 (S113).

Arithmetic device 11A receives the display range and the deformation condition (S114).

Arithmetic device 11A determines whether the image deformed by coordinate conversion table 135 generated in step S113 satisfies the display range and the deformation condition received in step S114 (S115). When the image is not displayed within the display range and/or when the deformation condition is not satisfied (NO in S116), arithmetic device 11A returns the process to step S102 and repeats the processing of steps S103 to S115.

Thereafter, arithmetic device 11A generates, and displays on display 14, projected feature point data 137 in which the projected feature points are arranged (S117).

In addition, arithmetic device 11A generates, and displays on display 14, non-projected feature point data 138 in which the non-projected feature points are arranged (S118).

Further, arithmetic device 11A generates visualized image data 136 using the coordinate conversion table 135 and displays visualized image data 136 on display 14 (S119).

In addition, arithmetic device 11A deforms the image using coordinate conversion table 135 generated in step S112 (S120).

Arithmetic device 11A operates virtual projector 20′ to project the image deformed in step S120 on virtual projection surface 40′ (S121).

When the image projected on virtual projection surface 40′ is as expected, the termination is operated, and the inspection processing in projection system 1 ends (YES in S122).

On the other hand, when the image projected on virtual projection surface 40′ is not as expected (NO in S122), the process returns to step S102 since readjustment is necessary, and the processing of steps S102 to S122 is repeated. Specifically, after the virtual space is adjusted with respect to the physical positions and the like of virtual projector 20′ and virtual imaging device 30′, the inspection processing is executed again.

As described above, according to image processor 10A according to the second exemplary embodiment, even in a case where there is no projection system, a virtual space in which a virtual projector is disposed is generated, and information generated in the processing of automatic geometric correction can be confirmed. Accordingly, it is possible to facilitate determination of validity of the geometric correction by the projector.

### Overview of Exemplary Embodiments

(1) An inspection method of the present disclosure is an inspection method of geometric correction in a projection system that causes a projector to project an image on a projection surface, the inspection method being executed by an arithmetic device accessing to a storage, the method including: storing, in the storage, a pattern image including a plurality of feature points indicating coordinates on an image to be projected by the projector onto the projection surface; and by the arithmetic device, causing the projector to project the pattern image onto the projection surface, acquiring from an imaging device first captured image data including the pattern image projected on the projection surface, comparing a feature point included in the first captured image data with each of the plurality of feature points included in the pattern image, to extract a plurality of non-projected feature points that are not to be projected on the projection surface, and generating non-projected feature point data in which the plurality of non-projected feature points extracted are arranged at corresponding positions in a range of a projection image to be projected by the projector.

Accordingly, it is possible to facilitate determination of validity of the geometric correction by the projector.

(2) In (1), the feature point included in the first captured image data may be compared with each of the plurality of feature points included in the pattern image, to extract a plurality of projected feature points that are projected on the projection surface, and projected feature point data in which the plurality of extracted projected feature points are arranged at corresponding positions may be generated on the projection surface captured by the imaging device.

Accordingly, it is possible to facilitate determination of validity of the geometric correction by the projector.

(3) In (2), the storage may store a marker image including a plurality of projection reference markers indicating coordinates on an image to be projected by the projector onto the projection surface, and the arithmetic device may cause the projector to project the marker image onto the projection surface, acquire from the imaging device second captured image data including the marker image projected onto the projection surface on which a plurality of disposition reference markers respectively corresponding to the plurality of projection reference markers are disposed, and use a result of comparison between positions of the plurality of disposition reference markers included in the second captured image data and positions of the plurality of projection reference markers to generate a coordinate conversion table for projecting the plurality of non-projected feature points onto the projection surface.

As a result, it is possible to generate the coordinate conversion table in which the projector appropriately adjusts the projection surface to the projection surface and projects the projection surface.

(4) In (3), visualized image data obtained by visualizing the plurality of projected feature points and the plurality of non-projected feature points may be generated using the coordinate conversion table.

As a result, it is possible to visually grasp a range of the image data to be projected on the projection surface and a range of the image data not to be projected.

(5) In (3) or (4), adjusted image data adjusted to project the image data as a whole onto the projection surface may be generated using the coordinate conversion table, and the projector may be caused to project the adjusted image data onto the projection surface.

As a result, how the image data is displayed can be confirmed using the coordinate conversion table.

(6) In any one of (3) to (5), determination may be made as to whether or not the display using coordinate conversion table 135 is display within a predetermined display range allowed for coordinate conversion, and a result of the determination may be output.

As a result, it is possible to confirm whether conversion into a predetermined display range is performed.

(7) In (6), designation of the predetermined display range may be received.

As a result, the user can designate the display range.

(8) In any one of (3) to (7), determination may be made as to whether or not display using the coordinate conversion table satisfies a predetermined deformation condition under which deformation of the image is allowed, and a result of the determination may be output.

Accordingly, it is possible to confirm whether or not the change is within a range satisfying the deformation condition.

(9) In (8), designation of the predetermined deformation condition may be received.

As a result, the user can designate the deformation condition.

(10) An inspection method of the present disclosure is an inspection method of geometric correction in a projection system that causes a projector to project an image on a projection surface, the inspection method being executed by an arithmetic device accessing to a storage, the method may include: storing, in the storage, space information of a real space in which the projector, the projection surface, and an imaging device capable of capturing the projection surface are disposed, parameter information set to the projector and the imaging device, and a pattern image including a plurality of feature points indicating coordinates on an image to be projected on the projection surface by the projector; and by the arithmetic device, generating virtual space information including a state in which a virtual projector and a virtual imaging device to which virtual parameter values based on the parameter information are set are disposed in a virtual space virtually constructed based on the space information, causing the virtual projector to project the pattern image onto a virtual projection surface in the virtual space information, acquiring virtual first captured image data including the pattern image projected onto the virtual projection surface, the virtual first captured image data being captured by the virtual imaging device, comparing a feature point included in the virtual first captured image data with each of the plurality of feature points included in the pattern image, to extract a plurality of non-projected feature points that are not to be projected onto the virtual projection surface, and generating non-projected feature point data in which the plurality of non-projected feature points extracted are arranged at corresponding positions in a range of a virtual projection image to be projected by the virtual projector.

As a result, even in a case where the virtual system does not actually exist, the determination of the validity of the geometric correction by the projector can be inspected by simulation.

(11) In (10), a feature point included in the virtual first captured image data may be compared with each of the plurality of feature points included in the pattern image, to extract a plurality of projected feature points that are projected on the virtual projection surface, and projected feature point data in which the plurality of projected feature points extracted are arranged at corresponding positions may be generated on the virtual projection surface captured by the virtual imaging device.

As a result, it is possible to facilitate determination of validity of the geometric correction by the projector by simulation.

(12) In (11), the storage may store a marker image including a plurality of projection reference markers indicating coordinates on an image to be projected by the projector onto the projection surface, and the arithmetic device may cause the virtual projector to project the marker image onto the virtual projection surface, acquire from the virtual imaging device virtual second captured image data including the marker image projected onto the virtual projection surface on which a plurality of virtual disposition reference markers respectively corresponding to the plurality of projection reference markers are disposed, and use a result of comparison between positions of the plurality of virtual disposition reference markers included in the virtual second captured image data and positions of the plurality of projection reference markers to generate a coordinate conversion table for projecting the plurality of non-projected feature points onto the virtual projection surface.

As a result, it is possible to generate the coordinate conversion table in which the projector appropriately adjusts the projection surface for projection by simulation.

(13) In (12), visualized image data obtained by visualizing the plurality of projected feature points and the non-projected feature point may be generated using a plurality of coordinate conversion tables.

As a result, the range of the image data to be projected on the projection surface and the range of the image data not to be projected can be visually recognized by simulation.

(14) In (12) or (13), adjusted image data adjusted to project the image data as a whole onto the virtual projection surface using the coordinate conversion table, and the virtual projector may be caused to project the adjusted image data onto the virtual projection surface.

As a result, it is possible to confirm how the image data is displayed using the coordinate conversion table by simulation.

(15) A computer program of the present disclosure causes an arithmetic device to execute the inspection method according to any one of (1) to (14).

Accordingly, it is possible to inspect determination of validity of the geometric correction by the projector.

(16) A projection system of the present disclosure is a projection system including: an arithmetic device accessing to a storage; a projector controlled by the arithmetic device to project an image onto a projection surface; and an imaging device capturing an image including the projection surface, in which the storage stores a pattern image including a plurality of feature points indicating coordinates on an image to be projected by the projector onto the projection surface; and upon inspection of the projection system, the arithmetic device causes the projector to project the pattern image onto the projection surface, acquires from an imaging device first captured image data including the pattern image projected on the projection surface, compares a feature point included in the first captured image data with each of the plurality of feature points included in the pattern image, to extract a plurality of non-projected feature points that are not to be projected on the projection surface, and generates non-projected feature point data in which the plurality of non-projected feature points extracted are arranged at corresponding positions in a range of a projection image to be projected by the projector.

Accordingly, it is possible to inspect determination of validity of the geometric correction by the projector.

The inspection method and the projection system described in claims of the present disclosure are achieved by hardware resources, for example, cooperation with a processor, a memory, and a computer program.

The inspection method, the computer program, and the projection system of the present disclosure are useful for realizing automatic geometric correction at the time of projection by the projector.

What is claimed is:

1. An inspection method of geometric correction in a projection system that causes a projector to project an image on a projection surface, the inspection method being executed by an arithmetic device accessing to a storage, the method comprising:
storing, in the storage, a pattern image including a plurality of feature points indicating coordinates on an image to be projected by the projector onto the projection surface; and
by the arithmetic device,
causing the projector to project the pattern image onto the projection surface,
acquiring from an imaging device first captured image data including the pattern image projected on the projection surface,
comparing a feature point included in the first captured image data with each of the plurality of feature points included in the pattern image, to extract a plurality of non-projected feature points that are not to be projected on the projection surface, and
generating non-projected feature point data in which the plurality of non-projected feature points extracted are arranged at corresponding positions in a range of a projection image to be projected by the projector.

2. The inspection method according to claim 1, comprising:
comparing the feature point included in the first captured image data with each of the plurality of feature points included in the pattern image, to extract a plurality of projected feature points that are projected on the projection surface; and
generating projected feature point data in which the plurality of projected feature points extracted are arranged at corresponding positions on the projection surface captured by the imaging device.

3. The inspection method according to claim 2, comprising:
storing, in the storage, a marker image including a plurality of projection reference markers indicating coordinates on an image to be projected by the projector onto the projection surface; and
by the arithmetic device,
causing the projector to project the marker image onto the projection surface,
acquiring from the imaging device second captured image data including the marker image projected onto the projection surface on which a plurality of disposition reference markers respectively corresponding to the plurality of projection reference markers are disposed, and
using a result of comparison between positions of the plurality of disposition reference markers included in the second captured image data and positions of the plurality of projection reference markers to generate a coordinate conversion table for projecting the plurality of non-projected feature points onto the projection surface.

4. The inspection method according to claim 3, comprising generating visualized image data obtained by visualizing the plurality of projected feature points and the plurality of non-projected feature points using the coordinate conversion table.

5. The inspection method according to claim 3, comprising:
generating adjusted image data adjusted to project the image data as a whole onto the projection surface using the coordinate conversion table; and
causing the projector to project the adjusted image data onto the projection surface.

6. The inspection method according to claim 3, comprising:
performing a determination as to whether or not display using the coordinate conversion table is display within a predetermined display range allowed for coordinate conversion; and
outputting a result of the determination.

7. The inspection method according to claim 6, comprising receiving designation of the predetermined display range.

8. The inspection method according to claim 3, comprising:
performing a determination as to whether or not display using the coordinate conversion table satisfies a predetermined deformation condition under which deformation of the image is allowed; and
outputting a result of the determination.

9. The inspection method according to claim 8, comprising receiving designation of the predetermined deformation condition.

10. An inspection method of geometric correction in a projection system that causes a projector to project an image on a projection surface, the inspection method being executed by an arithmetic device accessing to a storage, the method comprising:
storing, in the storage,
space information of a real space in which the projector, the projection surface, and an imaging device capable of capturing the projection surface are disposed,
parameter information set to the projector and the imaging device, and
a pattern image including a plurality of feature points indicating coordinates on an image to be projected on the projection surface by the projector; and
by the arithmetic device,
generating virtual space information including a state in which a virtual projector and a virtual imaging device to which virtual parameter values based on the parameter information are set are disposed in a virtual space virtually constructed based on the space information,
causing the virtual projector to project the pattern image onto a virtual projection surface in the virtual space information,
acquiring virtual first captured image data including the pattern image projected onto the virtual projection surface, the virtual first captured image data being captured by the virtual imaging device,
comparing a feature point included in the virtual first captured image data with each of the plurality of feature points included in the pattern image, to extract a plurality of non-projected feature points that are not to be projected onto the virtual projection surface, and
generating non-projected feature point data in which the plurality of non-projected feature points extracted are arranged at corresponding positions in a range of a virtual projection image to be projected by the virtual projector.

11. The inspection method according to claim 10, comprising:
comparing the feature point included in the virtual first captured image data with each of the plurality of feature points included in the pattern image, to extract a plurality of projected feature points that are projected on the virtual projection surface; and
generating projected feature point data in which the plurality of projected feature points extracted are arranged at corresponding positions on the virtual projection surface captured by the virtual imaging device.

12. The inspection method according to claim 11, comprising:
storing, in the storage, a marker image including a plurality of projection reference markers indicating coordinates on an image to be projected by the projector onto the projection surface; and
by the arithmetic device,
causing the virtual projector to project the marker image onto the virtual projection surface,
acquiring from the virtual imaging device virtual second captured image data including the marker image projected onto the virtual projection surface on which a plurality of virtual disposition reference markers respectively corresponding to the plurality of projection reference markers are disposed, and
using a result of comparison between positions of the plurality of virtual disposition reference markers included in the virtual second captured image data and positions of the plurality of projection reference markers to generate a coordinate conversion table for projecting the plurality of non-projected feature points onto the virtual projection surface.

13. The inspection method according to claim 12, comprising generating visualized image data obtained by visualizing the plurality of projected feature points and the plurality of non-projected feature points using the coordinate conversion table.

14. The inspection method according to claim 12, comprising:
generating adjusted image data adjusted to project the image data as a whole onto the virtual projection surface using the coordinate conversion table; and
causing the virtual projector to project the adjusted image data onto the virtual projection surface.

15. A non-transitory recording medium recording a computer program causing the arithmetic device to execute the inspection method according to claim 1.

16. A non-transitory recording medium recording a computer program causing the arithmetic device to execute the inspection method according to claim 10.

17. A projection system comprising:
an arithmetic device accessing to a storage;
a projector controlled by the arithmetic device to project an image onto a projection surface; and
an imaging device capturing an image including the projection surface,
wherein the storage stores a pattern image including a plurality of feature points indicating coordinates on an image to be projected by the projector onto the projection surface; and
upon inspection of the projection system, the arithmetic device causes the projector to project the pattern image onto the projection surface, acquires from the imaging device first captured image data including the pattern image projected on the projection surface,
compares a feature point included in the first captured image data with each of the plurality of feature points included in the pattern image, to extract a plurality of non-projected feature points that are not to be projected on the projection surface, and
generates non-projected feature point data in which the plurality of non-projected feature points extracted are arranged at corresponding positions in a range of a projection image to be projected by the projector.
